(19) United States
(12) Patent Application Publication
(10) Pub. No.: US 2026/0071018 A1
(43) Pub. Date: Mar. 12, 2026

(54) Gripper molecules for improving traction on ice

(71) Applicant: Mark Andrew Penick, San Antonio, TX (US)

(72) Inventor: Mark Andrew Penick, San Antonio, TX (US)

(21) Appl. No.: 18/831,198

(22) Filed: Sep. 9, 2024

(51) Int. Cl. C08F 220/58; A43B 13/04; B60C 1/00; C08F 220/18

(52) U.S. Cl. CPC C08F 220/58; C08F 220/1808; A43B 13/04; B60C 1/0016

(57) ABSTRACT

If there was a material that by its nature could get a good frictional grip on ice, people could use it to walk or drive on ice safely. Such a material needs molecules that have some means of inherently binding to ice. This patent describes a set of such molecules, which likely work by replacing water molecules in the ice crystal lattice.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not Applicable

### STATEMENT REGARDING AUTHORSHIP

No part of this application was created using a content-generating artificial intelligence chatbot in the style of ChatGPT or Midjourney, or any comparable device of similar capabilities.

### FIELD OF THE INVENTION

This invention relates to the problem of traction on ice by providing gripper molecules that could be incorporated into plastics or polymers to improve traction on ice. These plastics or polymers could be used for shoe soles, tire treads or any other article of manufacture needing traction on ice to perform its function.

### BACKGROUND OF THE INVENTION

The great majority of materials used for flooring, pavement, walking trails, etc., have enough surface friction to allow for safe walking or driving on them. Ice is notorious for being an exception. I set out to deal with this hazard by producing materials that by their nature resist sliding on ice.

### SUMMARY OF TIE INVENTION

If there was a material that by its nature could get a good frictional grip on ice, people could use it to walk or drive on ice safely. Such a material needs molecules that have some means of inherently binding to ice. I describe a set of such molecules here. I believe they work by replacing water molecules in the ice crystal lattice. I describe this below.

The requirements for such molecules seem to be as follows:
1. At least one, but preferably two or more carbonyl groups, or other polar groups, situated at such distances so that they can insert into the top layer of the crystal structure of ice. To do this they have to deploy oxygen atoms at distances at or near 4.51 Angstroms or 7.81 Angstroms, the distances between nearest oxygen atoms in the top layer of the ice structure.
2. The distances seem to be important, so the supporting chemical structure holding them in place should be fairly rigid. Flexible gripper molecules work poorly or not at all.
3. One of the polar groups needs to be attached directly to a polymer chain,
4. Said polar groups must not be able to donate hydrogen bonds, only accept.
5. Said polar groups must insert an oxygen atom into the ice lattice to accept hydrogen bonds. To make the importance of this clear, consider a secondary amide RCONHR′ versus a tertiary amide RCONR′R″. A secondary amide can rotate such that either its NH bond or its C═O bond is pointing down towards the ice surface. If the C═O bond is down, the oxygen atom can accept up to three hydrogen bonds to itself from the water molecules in the ice. Or, if the NH bond is down, it can donate only one hydrogen bond to the nearest water molecule. However, crystallization is known to be exclusive. In other words, water is the preferred molecule to enter the ice crystal lattice and others will tend to be excluded. Thus the amide may not enter the ice lattice, making the undesired mode of NH hydrogen bond donation more likely. However, tertiary amides do not have this choice, as they have no NH to bond with. If the amide nitrogen bears hydrophobic groups these may prefer to stay in the polymer matrix rather than contact the ice. This would force the C═O to rotate downwards to where the oxygen atom can replace a water molecule in the top layer of the lattice and accept 1, 2, or 3 hydrogen bonds,

Suitable polar groups that could be incorporated into ice-gripping monomers are generally strong acceptors of hydrogen bonds, including but not limited to ketone, ester, amide, and fully substituted urethanes and ureas; phosphorus-containing groups including but not limited to phosphine oxides, phosphinate esters, phosphinic acid amides, phosphonate esters, phosphonic acid amides, phosphoramidic esters, phosphate ester amides, and phosphoric triamides; sulfur-containing groups including but not limited to sulfoxides, sulfones, sulfinamides, sulfonamides, sulfoximides and sulfonimidamides.

### BRIEF DESCRIPTION OF THE FIGURES

FIG. 1—Necessary structure for gripping ice, showing two double-bonded oxygen atoms positioned for gripping. RF=Rigid Framework, P=polymer chain.

FIG. 2—General embodiments [simple] for ice-gripping monomers.

FIG. 3—General embodiments [complex] for ice-gripping monomers.

FIG. 4—Exemplary embodiments for ice-gripping monomers.

FIG. 5—Sketch of ice Lattice showing the important distances, seen from the side.

FIG. 6—Sketch of [exemplary embodiment] gripper molecule binding to ice.

### DETAILED DESCRIPTION OF THE INVENTION AND EXEMPLARY EMBODIMENTS

The exemplary embodiment of the invention consists of a monomer that can be mixed with other monomers to create copolymers with desirable properties. The monomers meet three main requirements: 1] one or more moieties that can participate in the polymerization reaction being used; 2] one or more oxygen atoms [preferably monocoordinate] held in the appropriate relative positions to bind to ice, by a relatively rigid framework; 3] one of the oxygen atoms is attached as close as possible to the polymer chain.

In practice a hydrophobic group that helps the monomer mix with other relatively hydrophobic monomers is helpful, however this may not be necessary for the ice-gripping function. A low glass transition temperature is also desirable, as the product plastic will then retain flexibility at low temperatures.

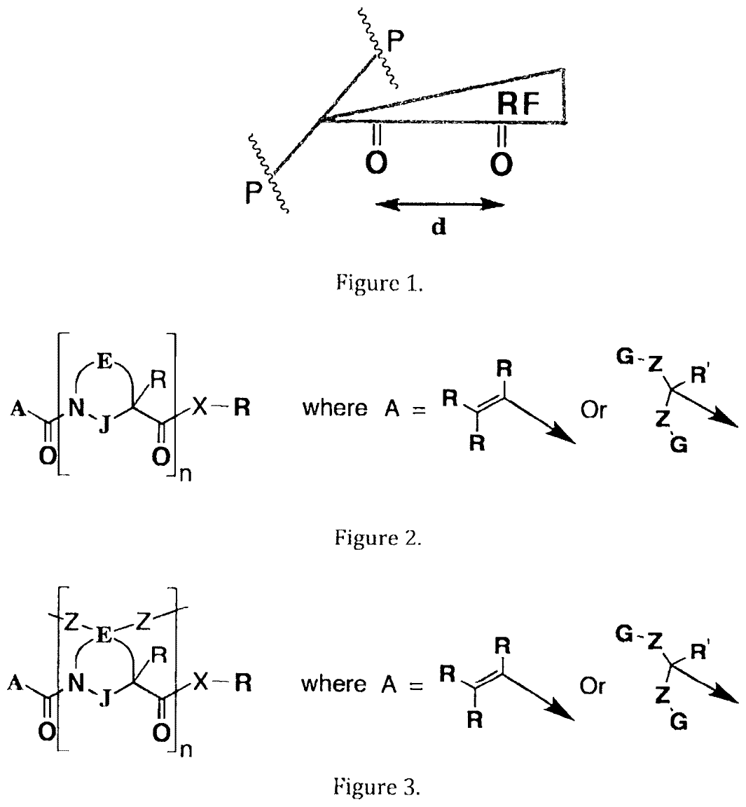

FIG. 1: necessary structure, where ‘P’ denotes the rest of the polymer chain [not shown], ‘d’ is the distance between the oxygen atoms involved in gripping, and ‘RF’ stands for ‘rigid framework’ RF does not have to be totally rigid but it must have enough rigidity to impose a preferred distance d at or near 4.51 or 7.81 Angstroms. RF may carry more than two oxygen atoms, and may be straight, curved or branched, but the distances between neighboring oxygen atoms used for ice-gripping must be at or near 4.51 or 7.81 Angstroms.

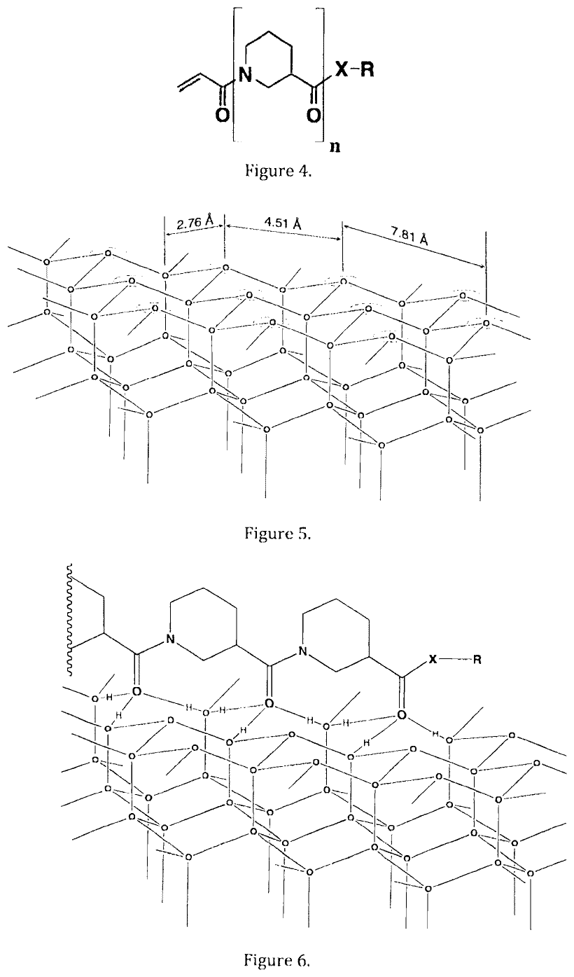

FIGS. 2 and 3: In order to describe all the possibilities, two general embodiments for ice-gripping monomers were necessary. FIG. 2 describes general embodiments that are more similar to the exemplary embodiments seen in FIG. 4.

FIG. 3 describes general embodiments that contain fused rings or molecules in which the A group is connected by fused rings to the rest of the gripper molecule, The A groups are used in polymerization; the unsaturated group for radical polymerization and the other for making polyurethanes, polyureas or polysiloxanes. Taking away the Z groups from the complex general embodiments gives the simple general embodiments.

FIG. 4: These are the exemplary embodiments. These include several closely related structures; X=NH or O, and R is methyl, n-dodecyl or n-octadecyl, and n=1-4.

FIG. 5 is a sketch of part of the ice lattice, seen from the side, with interatomic distances shown.

FIG. 6 is a sketch of part of a [exemplary embodiment] gripper molecule binding to ice. Here the inter-carbonyl distance is near 4.51 Angstroms and the lattice is seen from the side. This illustrates the method of a polyamide gripper molecule gripping ice by inserting its oxygen atoms into the ice surface [basal plane]. For clarity the only hydrogen atoms shown are those directly involved in hydrogen bonding to the gripper molecule. The others, which participate in the hydrogen bonds holding the ice lattice together, arc ‘disordered’, meaning they may be assumed to move back and forth along the lines joining the oxygen atoms. The area to the left of the wavy line may contain another six-membered ring or a polymer chain. X and R are the same as specified in FIG. 2.

For the general embodiments in FIGS. 2 and 3, R groups need not all be the same and can be independently selected from H, D, CH₃, C₂H₅, alkyl, branched alkyl, iso-alkyl, cycloalkyl, alkene, alkyne, arene, halogen, an alkyl or arene group substituted with further functional groups of its own, or another polymer, or a hydrophobic alkyl, arylalkyl, haloalkyl, or arylhaloalkyl group or a silyl group or silicon-containing alkyl or alkaryl group bearing any of the aforementioned groups.

The integer n ranges from 1 to 6. The R′ group, part of A, can be selected from the list of R groups, or it can be a third group like the other two —Z-G groups. G groups can be independently selected from OH, NH₂, NHR, SH, NCO [isocyanate] or NCS [isothiocyanate], COOH, COOR, COSR, or a hydrolyzeable silicon-based group [RO]₃Si, [RO]₂SiR, ROSiR₂, [R₂N]₃Si, [R₂N]₂SiR or R₂NSiR₂. The R groups of NHR, COOR, COSR or [RO]₃Si, [RO]₂SiR or ROSiR₂, [R₂N]₃Si, [R₂N]₂SiR or R₂NSiR₂ can be selected from the list of R groups provided above, or in addition hydroxyalkyl, hydroxyaryl, hydroxyalkylaryl, aminoalkyl, aminoaryl, or aminoalkylaryl; or halogenated and/or silicon-containing derivatives of hydroxyalkyl, hydroxyaryl, hydroxyalkylaryl, aminoalkyl, aminoaryl, or aminoalkylaryl. In the case of [RO]₃Si, [RO]₂SiR or ROSiR₂ the R on oxygen could also be an acyl or acylimino group. The groups E and J may be independently selected from —[CR₂]m-; —[CR₂]p-Y—[CR₂]q- where Y is a multivalent group including but not limited to O, S, Se, Te, alkene, haloalkene, alkyne, aryl, alkylaryl, halogen, haloaryl, alkylaryl bearing halogens, any of these groups also bearing O, S, Se, Te, —SiR₂—; Y may also contain polar groups such as but not limited to any of the ‘suitable polar groups’ listed above. R groups are independently selected from the list above, and m, p, and q can be 0-7. E, J, R and X are the same for FIG. 3 are the same as for FIG. 2. The groups Z are multivalent groups that connect neighboring rings, creating either spiro ring junctions or a fused ring system, for the purpose of promoting rigidity. Z groups may also connect to R groups. Z groups may be independently selected from —[CR₂]m-; —[CR₂]p-Y—[CR₂]q- where Y is a multivalent group including but not limited to 0, S, Se, Te, alkene, haloalkene, alkyne, aryl, alkylaryl, halogen, haloaryl, alkylaryl bearing halogens, any of these groups also bearing O, S, Se, Te, —SiR₂—; Y may also contain polar groups such as but not limited to any of the ‘suitable polar groups’ listed above. Z might have no atoms in it at all; in other words just a bond. Taking away the Z groups from the complex general embodiments gives the simple general embodiments.

R groups are independently selected from the list above, and m, p, and q can be 0-7. The R′ group, part of A, can be selected from the list of R groups, or it can be like the other two —Z-G groups. Z is as specified above. G groups can be independently selected from OH, NH₂, NHR, SH, NCO [isocyanate] or NCS [isothiocyanate], COOH, COOR, COSR or [RO]₃Si, [RO]₂SiR or ROSiR₂. The R groups of NHR, COOR, COSR or [RO]₃Si, [RO]₂SiR, ROSiR₂, [R₂N]₃Si, [R₂N]₂SiR or R₂NSiR₂ can be selected from the list of R groups provided above, or in addition hydroxyalkyl, hydroxyaryl, hydroxyalkylaryl, aminoalkyl, aminoaryl, or aminoalkylaryl; or halogenated and/or silicon-containing derivatives of hydroxyalkyl, hydroxyaryl, hydroxyalkylaryl, aminoalkyl, aminoaryl, or aminoalkylaryl. In the case of [RO]₃Si, [RO]₂SiR or ROSiR₂ the R on oxygen could also be an acyl or acylimino group.

Note: the second carbonyl, the one connected to ‘x’ in FIG. 4, can also be an ester instead of an amide; but amides are preferred.

Copolymers made using N,N-dibutylacrylamide, which has no second carbonyl group, were found to excellent coefficients of friction at temperatures below 0° C.

Thus, N,N-dibutylacrylamide is probably a good ingredient to put into any ice-gripping polymer formulation. Copolymers made using other dialkylacrylamides [R groups independently selected from the list above] may be expected to do likewise. X=NH, NR′, O or S; R groups can be independently selected from H, D, CH₃, C₂H₅, SiR″₃, alkyl, branched alkyl, iso-alkyl, cycloalkyl, alkene, alkyne, arene, an alkyl or arene group substituted with further functional groups of its own, another polymer, or a hydrophobic alkyl, arylalkyl, haloalkyl, or arylhaloalkyl group or a silyl group bearing any of the aforementioned groups. R′ and R″ can be independently selected from H, CH₃, C₂H₅, alkyl, branched alkyl, iso-alkyl, cycloalkyl, alkene, alkyne, arene, haloalkyl, haloaryl, haloalkylaryl, an alkyl or arene group substituted with further functional groups of its own, or another polymer, or a hydrophobic alkyl, arylalkyl, haloalkyl, or arylhaloalkyl group or a silyl group hearing any of the aforementioned groups. The integer n ranges from 1 to 6.

### Preparation of Gripper Molecules Shown in the Exemplary Embodiments

1. FIG. 4 where n=1, X=O and R=CH₃. Methyl piperidine-3-carboxylate is dissolved in acetonitrile and tricthylamine added. The solution was cooled in ice and acryloyl chloride added. Ethyl acetate and hexane were added to help precipitate triethylamine hydrochloride and the mixture filtered, washed with alkaline brine, then acidic brine and dried with sodium bicarbonate. Volatiles were removed, then the ester amide extracted 2× with hexanes. Pure by proton NMR.
2. FIG. 4 where n=1-4, X=NH and R=n-C₁₂H₂₅. Under nitrogen, piperidine-3-carboxylic acid is reacted with 1.1 equivalents of carbonyldiimidazole [CDI] in anhydrous dimethylacetamide [DMA] with a catalytic amount of triethylamine hydrochloride present [about 0.2 equivalent to the acid]. This mixture is stirred lor three or four days at room temperature. [It must not be heated or products from side reactions will predominate.]A precipitate will develop during the first day and then redissolve. This reaction can be followed by LC-MS [water-acetonitrile] and will be found to have made oligomers of piperidine-3-carboxylic acid. The amine end is protected with an acylimidazole moiety; the carboxyl end usually exists as COOH but may be an acylimidazole. The difference can be assessed by quenching the sample in methanol to give esters which will survive the LC-MS. Often both acids and methyl esters of n=1-4 oligomers arc seen. Sometimes small amounts of n=5 and n=6 are seen also. No attempt is made to separate the various oligomers or their further reaction products as they are all expected to be able to grip ice.

More CDI is added in portions. 30-40% of the initial amount used is needed at this stage.

When the reaction is finished, quenching a sample in methanol shows only methyl esters and no acids by LC-MS. This means all the carboxyl groups are activated by conversion to acylimidazoles.

Then the reaction vessel is flushed with nitrogen to remove carbon dioxide from the reaction [the presence of which can be verified with lime water]. Laurylamine and triethylamine are added, and the reaction stirred overnight. Reverse phase TLC in MeCN/H₂O can tell if it has progressed but usually LC-MS [of a sample quenched in MeOH] is needed to verify that it has finished.

Once there is no more oligomeric acid left, the mixture is diluted with water to about 60:40 DMA/water and extracted with hexanes. The gripper molecules are potent surfactants and this does give an emulsion but it breaks in half an hour or so. The hexanes remove unreacted laurylamine and some DMA. The hexane is washed with water and dried. Rotary evaporation and weighing of the residue tells how much laurylamine is left over, thus how much reacted. From that the total number of millimoles of molecules containing a C₁₂ ‘handle’ is known. This includes both useable and malformed gripper molecules.

Next, aqueous solutions of CaCl₂ and KOH [1:2 molar ratio] are added. [The number of millimoles of CDI added above, to connect laurylamine, is the minimum number of millimoles of CaCl₂ needed here.] Acetone is used to redissolve the organics if they precipitate. The mixture is heated overnight at 65-70° C. under nitrogen. This removes the acylimidazole moiety on the nitrogen end of the oligomer, and gives calcium carbonate. Some of the acylimidazole will not hydrolyze for reasons that are not clear; it may have rearranged to a carbon-linked isomer. Reverse phase TLC in MeCN/H₂O or LC-MS can assess when the reaction stalls. NMR can verify loss of the N-linked acylimidazole moiety.

The mixture is filtered to remove precipitated CaCO₃ and acetone is removed in vacuo.

The mixture is diluted with more water till it begins to get cloudy.

The gripper molecules are collected using Silicycle™ C₁₈ solid phase extraction cartridges. After adjusting pH to near neutral if necessary, and pre-washing the cartridges with methanol and water, the polar phase from the extraction is put through the cartridge[s], followed by enough water to wash off imidazole, DMA, metal salts and any other polar constituents. Once these are gone the gripper molecules can be efficiently removed with methanol. The solvent front can be found by watching the drops of eluate glide across a glass surface, such as the inside of a test tube. The water moves drop by drop but methanol is less viscous and wets the glass better than water does. The methanol solution is collected and dried over 3 A molecular sieves. Evaporating a drop of methanol eluate on a microscope slide will show when no more material is coming off the cartridge. The methanol is then removed in vacuo. At this point the weight of the residue and the millimoles of laurylamine used give [roughly] the average molecular weight of the material.

As this is a mixture of related molecules, NMR spectra are not distinct and integration is used to assess the value of n. This is done by integrating the methyl triplet at 0.88 ppm and assigning it as 3 hydrogens. Every other integration is compared to this one. The rest of the integrations are added up and 22 subtracted from the total [for the 11 CH₂ groups in laurylamine], and the remainder divided by 9 [the number of ring protons on piperidine-3-carboxylic acid].

The final step in gripper molecule preparation is acylation with acryloyl chloride. The material from the Silicycle extraction is dissolved in dry acetonitrile and triethylamine added. The solution is cooled in ice and a freshly prepared solution of acryloyl chloride in dry acetonitrile added in small portions. The solution was stirred overnight and ethyl acetate added to help precipitate triethylamine hydrochloride. The suspension was filtered and the filter cake washed with 1:1 acetonitrile/ethyl acetate. Water was added to hydrolyze unwanted water-sensitive byproducts. After 2 hours the solvents were removed in vacuo. The product was redissolved in acetonitrile and methanol and water added till solution just begins to get cloudy. Gripper molecules are collected using Silicycle™ C₁₈ solid phase extraction cartridges. First the gripper molecule solution is put through the cartridge, then water, then the gripper molecules are washed off with acetone. The solution is dried over molecular sieves and a trace of 4-ethylphenol is added as inhibitor, then solvents removed in vacuo to give the monomer mixture as a very viscous liquid.

The integrations of the acryloyl moiety protons are usually found to be around 0.5, instead of near 1.0 as they should be. Thus there are a lot of molecules in the final product that can't pick up an acryloyl group and participate in polymerization. There's always room for improvement.

I envision these molecules to be added to mixtures of suitable monomers and polymerized by free-radical initiators such as AIBN to form articles of manufacture including but not Limited to overshoes, shoe soles, tire treads, tire-chain like devices to fit over existing tires and snowmobile brakes. In other words, any devices that require traction on frozen water to perform their function can benefit from use of these gripper molecules.

### EXPERIMENTAL SECTION

The friction data for gripper molecules given here, was obtained with homemade equipment. In order to make it clear how the data was gathered, a description is needed. The equipment and data processing spreadsheets are all homemade and thus unique. [I found little guidance from the literature.] However, the subject of this patent is not the testing equipment but the gripper molecules the homemade equipment was made to test. Thus only verbal descriptions of the test equipment are provided.

### Molds for Production of Small Plastic Sheets

To test ice-gripping molecules there must be a method to measure the force needed to drag them across a piece of ice. As molecules are too small to grasp individually, they must first be attached to or incorporated in giant molecules, or in other words, a piece of plastic. The plastic should be strong enough to be held by some device and dragged across a slab of ice, such that the force needed to drag it can be measured. Thus molds were needed that enclosed a thin flat space so that they would produce small thin flat sheets of plastic containing gripper molecules.

To serve this purpose, two aluminum molds were made from flat aluminum slabs and heat resistant gaskets. Each slab had six holes for bolts that held the two slabs together. These pressed against a rectangular rubber gasket, such that a thin flat space [0.79 mm thick according to the specs of the gasket material] was enclosed.

Depending on the gasket size, the space thus enclosed would hold from 1 to 3.3 mLs of liquid. The upper slab had a 7th hole for addition of monomer mixture, which was tapped so that a bolt could close it after the monomer mixture was added. The end of said bolt was smoothed with a file. The inside surfaces of the molds were smoothed with 600 grit sandpaper so that. the resulting polymer samples would not have ridges or bumps that could dig into ice during testing, and make the COF appear to be higher than it actually was.

Two molds answering this description were produced. The small mold measured 6×2.5 inches and the large one, 6×4 inches. In use, the molds rested on flat aluminum bars heated by a hot plate. To make a pathway for heat transfer to the top of the mold, thin sheets of brass or copper were wedged between the aluminum slabs of the mold. These molds made it possible to test small [150-400 mg] batches of gripper molecules.

Before use, the inside surfaces of the mold were cleaned and treated with a solution of magnesium stearate in isobutanol. This left a thin layer of magnesium stearate on the aluminum for the purpose of assisting release of the plastic. A gasket was cut from a sheet of the gasket material and placed it between the aluminum slabs with the treated surfaces facing inward. The mold was clamped tightly with six bolts and wing nuts to finger tightness [which was always enough to prevent leaks].

The monomer mixture and initiator [azo-bis-isobutyronitrile or AlBN] was syringed into this apparatus and heated it for an hour to an hour and twenty minutes at 80-95 C. The hot plate used was tilted at a 9-10 degree angle to make the monomers flow to one end of the mold, which gave a better quality sample without large voids.

Temperature was monitored with a solid-state probe taped to the upper surface and the mold was covered with a little tent of aluminum foil to retain heat. This gave a solid polymer sample, which often peeled off the mold surface without tearing.

The polymer samples were cleaned with alcohols to remove magnesium stearate before testing on ice. Each sample was also photographed, so that it could still be identified if its label was lost.

Apparatus for measuring coefficient of friction [COF] on ice.

A T-shaped apparatus that extended into a cold chamber was built to do the tests.

The long arm of the T went into the cold chamber and held the polymer sample against a flat slab of ice. The short arms of the T had wheels. This apparatus allowed control of the temperature around the sample, to put weight on it, and to drag it horizontally across a smooth flat slab of ice, while measuring the force needed to drag the sample. [The front edge of the sample was unsupported and did not bear weight, so it could not dig into the ice.] Said cold chamber had copper manifolds inside it, cooled by dry ice, but the carbon dioxide was vented outside the chamber so as not to affect the ice surface. Knowing the weight applied to the sample and the force needed to drag it allows the operator to graph the COF. The data from each test was graphed.

Spreadsheets for processing COF data.

Data was gathered at 50 Hz for most of these, by a PASCO force sensor and PASCO software. The only exception was the 14p132 ZDAT tests [see following page for definition of ‘ZDAT’] for which I forgot to switch the software to 50 Hz from its default value of 20 Hz. So those tests are all at 20 Hz; the error wasn't noticed till much later. However, this should not affect the accuracy of the COF measurements.

I created my own method to work up the friction data, which I describe below, There seems to be little in the way of such methodology in the literature.

The data from the force sensors was converted to COFs by spreadsheet. A spreadsheet was configured to do this and plot a graph of COF vs. time. This was labeled a “data receptacle” spreadsheet and a new copy was made for each test. The data was exported from PASCO as comma-separated values, then cut and pasted into the data receptacle spreadsheet. These took each data point divided the force by the known load on the sample, rounded the product to two places, and graphed the data. A screen shot was taken of each graph.

COF vs. time data was converted by PATDR spreadsheets into the percentage of time, during a test, that a given gripper plastic sample was above a certain COF threshold. “PATDR” stands for “Percent Above Threshold Data Receptacle”. As above, a new copy was made for each test. These used the IF function: IF any given COF data point was above the threshold specified in a given column, the function returned the value of 1; else, value of 0. Each spreadsheet had 5 such columns.

Their specified thresholds were COF>0, COF>0.4, COF>0.5, COF>0.7 and COF>1.0. The sum of all the ones in each column was calculated. The column with threshold of zero of course had the largest sum. Said sum is the total number of data points. The sums of the other columns were divided by the sum of the COF>0 column to give the percentage of time, during the trial, in which the sample showed a COF above that particular threshold. For comparison, OSHA recommends a COF of 0.5 as a minimum for safe walking, and car tires on pavement span a COF range of 0.72-1.0.

These results were imported into a third spreadsheet called “PATDR results” where they were averaged. That is the genesis of the data given in the examples below. [Of course these will not sum to 100%.]4 kinds of tests were done: simple, falling, ZDAT, and falling ZDAT.

The simple test is one where the gripper plastic under load was placed on a smooth slab of ice and dragged across it at an ambient temperature below freezing. This is the most basic method of measuring the COF: The load on the sample is known and the sideways force is increased until the sample slides. Here, the simple was in contact with the ice before the sideways force was applied.

In a ‘falling’ test, the sample was above the ice because the test apparatus was supported. When the sideways force was applied, the support fell over. This way the sample was immediately under both load and sideways force from the moment it hit the ice. This mimics what happens when you step on a sheet of ice. ‘ZDAT’ stands for Zero Degrees Ambient Temperature. In the ZDAT tests, the temp of the cold chamber was allowed to rise a few degrees above OC, so that the ice just began to melt and had a thin layer of water on it. The sample was placed on the ice and dragged as in the simple test above. This mimics ice on a spring day when it's warm enough outside that the ice is starting to melt—and thus is at its most treacherous.

A ‘falling ZDAT’ test combines the previous two—the sample hits ice that is starting to melt. This mimics stepping on a sheet of ice on a spring day.

Due to time constraints not all tests could be conducted on all samples. However, all the gripper molecules discussed here are supposed to be able to insert the oxygen atom of an amide carbonyl into the crystal lattice at the surface of the ice. Thus, they were all working in basically the same way to generate friction.

### Gripper Molecule Preparations.

It is obvious that the gripper molecules discussed in the first two examples [dibutylacrylamide and N-acryloyl-piperidine-3-carboxylate methyl ester] are much easier to prepare than the oligo-amides. But the extra effort was justified, as the oligo-amides were found to be almost indifferent to the ZDAT conditions of ambient temperature and the onset of melting. They worked nearly as well when the ice was starting to melt, as they did when the ambient temperature was below freezing. The oligo-amides had two theoretical justifications. First, amides are more polar than esters, thus hydrogen bonds from ice to the amide carbonyls should be stronger than the corresponding hydrogen bonds to ester carbonyls, and those stronger hydrogen bonds should give a better grip. Second, some of these oligomers could put down 3 or 4 carbonyls onto the ice surface, with up to 3 hydrogen bonds expected to each, giving the strongest possible bond to the ice surface.

### Example 1. N,N-Dibutylacrylamide [DBA]

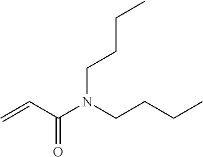

In a dry 100 mL round flask, 26 mL of anhydrous acetonitrile was mixed with 6.2 mL [37 mmol] of dibutylamine. 1.5 mL of acryloyl chloride [18.5 mmol] was mixed with 8 mLs of anhydrous acetonitrile. The dibutylamine solution was cooled in ice to about 3 degrees Centigrade and the acryloyl chloride solution slowly added. The reaction was very exothermic and the mixture became difficult to stir. After stirring 2 more hours at 4 C the mixture was filtered. A few drops of butylated hydroxytoluene [BHT] solution in hexanes was added as a polymerization inhibitor. Acetonitrile was removed under vacuum. The residue was partitioned between hexanes and dilute aqueous HCL. Phases were separated and the hexane phase washed with dilute aqueous HCl until it came out acidic [2 more washes]—The hexane phase was washed once more with water, then dried over 3 Angstrom molecular sieves, and most of the hexanes removed under vacuum. Not all the hexanes would distill out; so methanol was added and removed under vacuum, causing the last of the hexanes to distill out. 3.035 g of a clear mobile liquid was obtained, 90%. This was stored at −20 C. Proton NMR was consistent with the proposed structure. The N—CH₂— proton resonances were noteworthy in that they were not equivalent. This is consistent with restricted rotation commonly seen in amides.

To prepare a polymer for testing, 205 microliters of DBA were mixed with 910 microliters of 2-ethylhexyl acrylate, 90 microliters of polyethylene glycol diacrylate [number average molecular weight 575], and 21 mgs of AIBN. This mixture was heated in the small mold for over an hour at 80 C. The plastic tore upon being removed from the mold, but it could still be tested. It was cleaned with ethanol and allowed to air dry overnight.

COFs achieved by polymers containing DBA were often spectacular, sometimes over 2.0, and in one case briefly reaching 2.94. But when tested above OC [ZDAT] the COFs melted away. The highest COF achieved during a ZLDAT test of a DBA copolymer was 0.39, and that only briefly.

### Results

| Test type | % >0.4 | % >0.5 | % >0.7 | % >1.0 |
|---|---|---|---|---|
| Simple | 95 | 94 | 92 | 86 |
| Simple [2^{nd} test set] | 88 | 86 | 78 | 55 |
| ZDAT | 0 | 0 | 0 | 0 |

### Example 2. N-acrytoyl-piperidine-3-carboxylate methyl ester [Ester amide.]

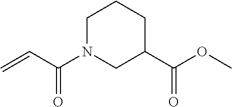

In a dry flask under nitrogen, 1.35 mLs [9.69 mmol] of triethylamine, 10 mL of dry acetonitrile and 1.26 mLs [9.33 mmol] of methyl 3-piperidine carboxylate were mixed and cooled in ice. 0.74 mL of acryloyl chloride [0.91 mmol] was mixed with 3.5 mLs of dry acetonitrile and added slowly. After stirring and thawing overnight 8 mLs each of ethyl acetate and hexanes were added and the mixture filtered. The filtrate was extracted with both acidic [HCl] and alkaline [NaHCO₃] brines. Both brines were back-extracted with ethyl acetate and the organic phases from these back-extractions added to the MeCN/EtOAc/hexanes solution. This solution was dried 2× over NaCl [first drying had a little NaHCO₃ added to the NaCl]. After rotary evaporation, the residue was diluted with acetone, filtered again and concentrated in vacuo. The ester amide is insoluble in hexanes so it was extracted with hexanes 2×. A few drops of 4-ethylphenol solution in hexanes was added to the ester to provide a polymerization inhibitor. The last of the hexanes was then removed in vacuo. 1.60 g [89%] of product, pure by proton NMR, was obtained as an orange oil. LC-MS showed the expected molecular weight of 197, and some absorption at 254 nm in agreement with the presence of an acrylamide.

To make a polymer suitable for testing, 0.5 mLs of the above monomer was mixed with 0.5 mLs of 2-ethylhexyl acrylate, 80 microliters of polyethylene glycol diacrylate [number average molecular weight 250], and 18 mgs of AIBN. This mixture was placed in the small mold described above and heated at 80-85 degrees C. for one hour and 15 minutes. Upon carefully opening the mold the flexible plastic easily broke free from the bottom half but had to be carefully peeled off the upper half using isopropanol. It was then cleaned with isopropanol and soaked 2× in methanol, then dried and tested by dragging it across a smooth ice surface. Two batches of this monomer were prepared; the above preparation is the better of the two. The first batch of ester amide contained about 10 mole % of acrylic acid by proton NMR [which at the time I thought was an acrylate ester. An acrylate ester impurity should not hinder the performance of the ester amide, since the polymer contained an acrylate ester already].

### First Batch Results:

| Test type | % >0.4 | % >0.5 | % >0.7 | % >1.0 |
|---|---|---|---|---|
| Simple | 86 | 82 | 56 | 13 |
| Falling | 82 | 75 | 50 | 5 |
| ZDAT | 85 | 75 | 26 | 0 |
| Falling ZDAT | 69 | 47 | 19 | 1 |

### Second Batch Results:

| Test type | % >0.4 | % >0.5 | % >0.7 | % >1.0 |
|---|---|---|---|---|
| Simple | 86 | 76 | 33 | 3 |

### Example 3. Functionalized Oligomers of 3-Piperidinecarboxylic Acid [Oligo-Amides]

I carried out this procedure several times but due to its length I am only writing out what the most optimized version would be like. This narrative is a fusion of the best parts of two preparations. The work ran far behind schedule and time was not available to finish the optimization. The oligo-amide monomers thus obtained were a mixture of different chain lengths and configurations [as 3-piperidinecarboxylic acid has a chiral center but the racemic acid was used here]. These were all expected to be able to grip ice, so I did not attempt to separate them.

Oligomer assembly. 653 mg [5.05 mmol] of 3-piperidinecarboxylic acid, 883 mg [5.44 mmol] of carbonyldiimidazole [CDI], and 130 mg [0.94 mmol] of triethylamine hydrochloride were placed in a dry flask under nitrogen and 9.9 mLs of dry N,N-dimethylacetamide [DMA, solvent.] added. This was stirred under balloon pressure of nitrogen for 3 days. [It is important that this reaction not be heated in an attempt to speed it up, as heat generates impurities. Heating the oligomerization reaction may cause attack of 3-piperidinecarboxylic acid on the N-acylimidazole moiety, giving urea derivatives with an acid group at each end.]

To assess the progress of the reaction, a sample is diluted in methanol and examined by reverse phase LC-MS on a C18 column. [Mobile phase was acetonitrile-water, spiked with formic acid, and a gradient was employed going from 10% acetonitrile to 5% water over 4 minutes.] The oligomers at this point have the following structure[s], where n is expected to be 1-5, with the main constituents being n=2 and n=3:

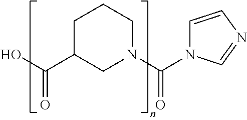

The carboxyl group may be free as shown or instead be an acylimidazole derivative. However the acylimidazole derivatives of carboxylic acids will react readily with methanol, thus trapping them as the methyl ester. By contrast the N-acylimidazole moiety on the other end was not observed to be reactive towards methanol. The methyl esters arc well separated from the acids and are easily found in the LC-MS data. When only methyl esters appear in the LC-MS data, the reaction is finished. The first MeOH test showed mainly n=2 and n=3 acids and no esters. A limewater test showed CO₂ in the head space above the reaction mixture. 350 mg [2.16 mmol] of CDI was added, followed by 85 mg [0.52 mmol] more the next day, as methanol test showed the reaction was not completed. A day and a half after addition of the 350 mg, the methanol test showed mostly methyl esters of the n=2-4 carboxylic acids.

Connecting a laurylamine ‘handle’. The oligomer is now ready to be joined to n-dodecylamine. The oligomers seem to be very hydrophilic, so connecting a dodecyl chain provides a greasy ‘handle’ to aid purification, and help them dissolve in the monomer mixture later.

The flask was flushed with nitrogen to get rid of the CO₂, then 477 mg [2.57 mmol] of n-dodecylamine was added, followed by 75 microliters [0.54 mmol] of triethylamine. There will be an equilibration between triethylamine hydrochloride and n-dodecylamine hydrochloride, which will interfere with the reaction of n-dodecylamine with the activated oligomer. Adding triethylamine should shift the equilibrium away from n-dodecylamine hydrochloride. The reaction was stirred over a weekend at room temperature. Afterwards LC-MS showed a lot of n=1-3 dodecylamides and some unreacted n-dodecylamine. The product dodecylamides at this point should be oligomers with a C₁₂ alkyl group at one end and an acylimidazole at the other, as shown here:

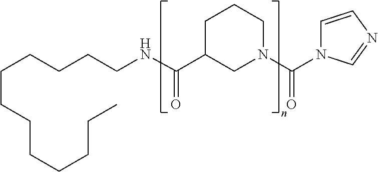

The reaction mixture was diluted with 8 mLs of water and extracted with 14 mLs of hexanes. This gave an emulsion that broke in 15-20 minutes, phases were separated and the extraction repeated. Phases were separated again and the separatory funnel rinsed with methanol to minimize losses of product. This was added to the lower phase, which was then rotavaped to remove any volatiles that would come off readily under house vacuum. Water and DMA were not removed, but were carried thru to the next stage.

Although not necessary, the oligo-amides at this stage can be collected by solid phase extraction. As this is a mixture of related molecules the data obtainable from proton NMR is limited. Peaks from the 3-piperidinecarboxamide moieties are mostly unresolved lumps, but signals of the N-acylimidazole aromatic hydrogens and most of the laurylamine moiety are obvious. It is possible to count the protons contributing to the 3-piperidinecarboxainide moieties, using the laurylamine methyl to provide a signal for 3H, and get values of n. Values of n from 2-4 were obtained, consistent with LC-MS data.

Hexane extraction collects and allows isolation of unreacted laurylamine. From this the number of millimoles of reacted laurylamine could be calculated. Since they react in a 1:1 ratio, [millimoles of reacted laurylamine]=[millimoles of gripper molecules]. The molecular weight and thus the average value of n can then be calculated from the weight of the sample.

Removal of acylimidazole. The N-acylimidazole group was then hydrolyzed in situ; workup is not necessary at this stage. 4 mLs of water was added to the mixture, followed by 236 mg [2.13 mmol] of CaCl₂ in 2.0 mL of water and 258 mg [4.61 mmol] of KOH dissolved in 3.0 mLs of water. Mixture was cloudy. 8 mLs of acetone was added in two portions and the reaction heated for a total of five days at an oil bath temp of 60 C. During this time LC-MS was used to follow its progress, and an additional 72 mg [0.65 mmol] of CaCl₂ and 87 mg [1.55 mmol] of KOH, each dissolved in 1.0 mL of water, and 4 mLs of acetone, were all added. Most but not all of the N-acylimidazole hydrolyzed. [It may be that the unhydrolyzed material was isomerized into a C-linked imidazole that hydrolyzes very slowly or not at all. Thus, perhaps all the material that successfully hydrolyzed, did so in a lot less than 5 days.]

The desired product at this point is a mixture of oligoamides with these structures:

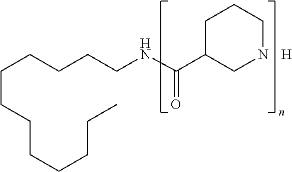

The mixture was filtered to remove CaCO₃, then acetone was removed by rotary evaporation and 24 mLs of water added to the residue. The oligomers were collected by solid-phase extraction. This operation was done using solid phase extraction [C₁₈ Silicycle™ SPE] cartridges. Before cartridges were used they were washed with methanol, then water, using balloon pressure to force the Liquids thru. Then a portion of the above solution was forced in with balloon pressure. The cartridge was washed with water until it came off at neutral pH, indicating all the imidazole was gone. At this point polar materials like DMA and KCl should be gone too. Then methanol was pushed thru, followed by 20% isopropanol in methanol.

The methanol front could be found by putting a drop of eluate on a microscope slide and watching how it wet the slide. Methanol spreads out much more than water does. Evaporating a drop of organic eluate on a microscope slide showed me if any material was still coming out of the cartridge. 689 mg of material was obtained after drying the eluate with 3 A sieves and rotary evaporation. Proton NMR showed loss of most of the acylimidazole moiety and molecular weights seen by LC-MS were consistent with the structures shown.

### Acryloylation of the Above Amines:

675 mg [believed to be 1.66 mmol] of the above mixture of oligoamides was dissolved in 6.5 mLs of dry acetonitrile and 0.97 mLs of dry DMA. 320 microliters [2.3 mmol] of triethylamine was added. This mixture was cooled in ice. 150 microliters [1.85 mmol] of acryloyl chloride was dissolved in 0.9 mLs of dry acetonitrile and added slowly. The mixture was kept cold for several hours and allowed to stir and thaw out overnight. The next day the mixture was filtered and the filter cake washed with 1:1 acetonitrile/ethyl acetate. About ⅔ mL of water [37 mmol] was added to the filtrate to hydrolyze any structure resulting from attack of acryloyl chloride on an amide oxygen. After two hours, the more volatile organic solvents were removed under house vacuum, and about 1.5 mLs of water added, which took the organics to the limits of solubility. [The mixture was seen to become cloudy,] The solution was put thru solid phase extraction COOH Silicycle™ SPE cartridges to remove unreacted amines. The cartridges were washed with methanol. The methanol was removed in vacuo and the residue purified with solid phase extraction [C₁₈ Silicycle™ SPE] cartridges in the same manner as outlined above, except that acetone instead of methanol was used to remove the material from the C₁₈ cartridge. 460 mg of acrylamide oligoamide monomer mixture was obtained as a viscous liquid. Monomer structures are:

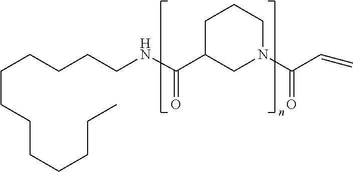

Proton NMR showed the presence of an acryloyl moiety and signals consistent with a mixture of oligomers with the structure shown. Counting protons showed there were more methyl groups than acryloyl groups, indicating the presence of oligoamides, apparently similar to the structures shown, that did not produce an acrylamide upon treatment with acryloyl chloride. Both LC-MS and high-resolution mass spectroscopy showed molecular weights consistent with the oligo-amides shown.

To prepare plastic, 160 mg of the above monomer mixture was mixed with 330 microliters of 2-ethylhexyl acrylate, 90 microliters of polyethylene glycol diacrylate [number average molecular weight 250], and 12 mgs of AIBN. The monomer mixture was dried over 3 A sieves, then heated in the small mold at 80 C for 1 hour and 10 minutes. Upon opening the mold the plastic peeled off both sides easily. It was washed 2× with methanol and cracked extensively. The plastic was then washed 2× with 2:1 methanol/water and dried over 3 A sieves under house vacuum. One piece big enough to test was obtained.

In the process of working out the above procedure, 5 batches of monomer were prepared and 3 used to make plastic. [There was not time to complete the others.] The step involving Silicycle™ solid-phase COOH extraction, done to remove unreacted amines, is likely unnecessary. I had planned to Look for unreacted amines by LC-MS, which would have been far more efficient, then add more acryloyl chloride to acylate them. But the hardware suffered a severe breakdown just days before my time in the incubator lab expired, and it could not be fixed in time. Had I been able to check for unreacted amines by LC-MS I would have done so and not done solid-phase COOH extraction.

### Results for Oligo-Amides

Batch 1 [n˜=3]:

| Test type | % >0.4 | % >0.5 | % >0.7 | % >1.0 |
|---|---|---|---|---|
| Simple | 86 | 82 | 37 | 1 |
| ZDAT | 82 | 70 | 25 | 4 |
| Falling ZDAT | 74 | 54 | 17 | 2 |

Batch 2 [n˜=2]:

| Test type | % >0.4 | % >0.5 | % >0.7 | % >1.0 |
|---|---|---|---|---|
| Simple | 76 | 63 | 19 | 0 |
| ZDAT | 68 | 49 | 14 | 0 |

Batch 3 [n˜2]:

| Test type | % >0.4 | % >0.5 | % >0.7 | % >1.0 |
|---|---|---|---|---|
| Simple | 83 | 66 | 31 | 3 |

In the course of the work a polymer containing glycidyl methacrylate [GMA] was made and tested as a control. Its polymer behaved like the ester amide, but less effectively. This puzzled me until I realized GMA is also set up to be a two-point gripper molecule, like the ester amide. GMA can use its ester carbonyl oxygen and its epoxide oxygen as the two atoms that receive hydrogen bonds from ice, and although GMA is more flexible than the ester amide, these two atoms can easily get close to 4.51 angstroms apart, That explains the COFs of the GMA polymers and gives further support to my hypothesis. However, GMA is a commercial product so I can't patent it, and so I don't present its numbers here.

From these results I conclude that gripper molecules comparable to those described, with three or more points of attachment, are likely to perform better than grippers with two, and certainly better than grippers with only one. It is crucial that the gripper molecules can continue to hold on even as the ice below them is starting to melt, and the oligo-amides seem to be able to do this.

1. A method for increasing traction of an article of manufacture on a surface comprising obtaining a composition containing molecules resembling the structures shown in FIGS. 1-3,
where ‘P’ denotes the rest of the polymer chain [not shown], ‘d’ is the distance between the oxygen atoms involved in gripping, and ‘RF’ stands for ‘rigid framework’,
wherein for the general embodiments in FIGS. 2 and 3, R groups need not all be the same and can be independently selected from H, D, CH₃, C₂H₅, alkyl, branched alkyl, iso-alkyl, cycloalkyl, alkene, alkyne, arene, halogen, an alkyl or arene group substituted with further functional groups of its own, or another polymer, or a hydrophobic alkyl, arylalkyl, haloalkyl, or arylhaloalkyl group or a silyl group or silicon-containing alkyl or alkaryl group bearing any of the aforementioned groups, the integer n ranges from 1 to 6, the R′ group, part of A, can be selected from the list of R groups, or it can be a third group like the other two —Z-G groups, G groups can be independently selected from OH, NH₂, NHR, SH, NCO [isocyanate] or NCS [isothiocyanate], COOH, COOR, COSR, or a hydrolyzeable silicon-based group [RO]₃Si, [RO]₂SiR, ROSiR₂, [R₂N]₃Si, [R₂N]₂SiR or R₂NSiR₂, the R groups of NHR, COOR, COSR or [RO]₃Si, [RO]₂SiR or ROSiR₂, [R₂N]₃Si, [R₂N]₂SiR or R₂NSiR₂ can be selected from the list of R groups provided above, or in addition hydroxyalkyl, hydroxyaryl, hydroxyalkylaryl, aminoalkyl, aminoaryl, or aminoalkylaryl; or halogenated and/or silicon-containing derivatives of hydroxyalkyl, hydroxyaryl, hydroxyalkylaryl, aminoalkyl, aminoaryl, or aminoalkylaryl;
in the case of [RO]₃Si, [RO]₂SiR or ROSiR₂ the R on oxygen could also be an acyl or acylimino group;
the groups E and J may be independently selected from —[CR₂]m-; —[CR₂]p-Y—[CR₂]q- where Y is a multivalent group including but not limited to O, S, Se, Te, alkene, haloalkene, alkyne, aryl, alkylaryl, halogen, haloaryl, alkylaryl bearing halogens, any of these groups also bearing O, S, Se, Te, —SiR₂—; Y may also contain polar groups such as but not limited to any of the ‘suitable polar groups’ listed above, R groups are independently selected from the list above, and m, p, and q can be 0-7;
E, J, R and X are the same for FIG. 3 are the same as for FIG. 2, the groups Z are multivalent groups that connect neighboring rings, creating either spiro ring junctions or a fused ring system, for the purpose of promoting rigidity, Z groups may also connect to R groups, Z groups may be independently selected from —[CR₂]m-; —[CR₂]p-Y—[CR₂]q- where Y is a multivalent group including but not limited to O, S, Se, Te, alkene,
haloalkene, alkyne, aryl, alkylaryl, halogen, haloaryl, alkylaryl bearing halogens, any of these groups also bearing O, S, Se, ′fc, —SiR₂—; Y may also contain polar groups such as but not limited to any of the ‘suitable polar groups’ listed above, Z might have no atoms in it at all; in other words just a bond. Taking away the Z groups from the complex general embodiments gives the simple general embodiments;
R groups are independently selected from the list above, and m, p, and q can be 0-7, the R′ group, part of A, can be selected from the list of R groups, or it can be like the other two —Z-G groups, Z is as specified above, G groups can be independently selected from OH, NH₂, NHR, SH, NCO [isocyanate] or NCS [isothiocyanate], COOH, COOR, COSR or [RO]₃Si, [RO]₂SiR or ROSiR₂. The R groups of NHR, COOR, COSR or [RO]₃Si, [RO]₂SiR, ROSiR₂, [R₂N]₃Si, [R₂N]₂SiR or R₂NSiR₂ can be selected from the list of R groups provided above, or in addition hydroxyalkyl, hydroxyaryl, hydroxyalkylaryl, aminoalkyl, aminoaryl, or aminoalkylaryl; or halogenated and/or silicon-containing derivatives of hydroxyalkyl, hydroxyaryl, hydroxyalkylaryl, aminoalkyl, aminoaryl, or aminoalkylaryl; in the case of [RO]₃Si, [RO]₂SiR or ROSiR₂ the R on oxygen could also be an acyl or acylimino group.
